(19) United States
(12) Patent Application Publication
(10) Pub. No.: US 2003/0225548 A1
(43) Pub. Date: Dec. 4, 2003

(54) Method and device for monitoring a machine

(76) Inventors: Jurgen Gunther, Stockheim (DE); Stefan Klump, Lichtenfels (DE)

Correspondence Address: LERNER AND GREENBERG, P.A., Post Office Box 2480, Hollywood, FL, 33022-2480, US

(21) Appl. No.: 10/377,894

(22) Filed: Feb. 28, 2003

Related U.S. Application Data
(63) Continuation of application No. PCT/DE01/03142, filed on Aug. 16, 2001.

(30) Foreign Application Priority Data
Aug. 28, 2000 (DE) 100 42 227.6

(51) Int. Cl. G06F 11/30; G06F 15/00; G21C 17/00

(52) U.S. Cl. 702/182

(57) ABSTRACT

A movable machine part of a machine controlled by a control program is monitored with little effort. To this end, the machine parts currently being controlled by the control program are identified and counted. The machine parts actually moved by the control program are simultaneously counted. When the numbers differ from one another, a fault message and identified machine parts as possible fault sources are displayed.

### CROSS-REFERENCE TO RELATED APPLICATION

This application is a continuation of copending International Application No. PCT/DE01/03142, filed Aug. 16, 2001, which designated the United States and was not published in English.

### BACKGROUND OF THE INVENTION

Field of the Invention

The invention relates to a method and a device for monitoring movements of moving machine parts of a machine that is controlled by a control program.

In many industrial fields, machines are used which are controlled by a program that runs in a controller of a stored-program control system. In such a control program there are definitions of which actions are to be performed by the machine at which point in time in the program run. To do this, the controller transmits instructions to the actuators of the machine parts, which instructions trigger, for example, a movement of the respective moving machine part at a specific point in time.

A further object of the controller is to monitor the actions of the machine parts—in particular their movement—which are triggered by the controller by instructions, in order to determine whether those actions of machine parts that are provided in the program run have actually taken place.

In this respect it is known that each action of a machine part actuates, for example, a feedback contact whose state is read in by the controller and further processed. A closed contact may signify here, for example, “action executed”. Usually, each action to be carried out by the machine part is assigned a feedback message to the controller, which feedback message is respectively triggered by a separate feedback contact. Therefore, the controller has to be configured to process at least as many feedback messages as there are feedback contacts. In a complex machine, this number may be considerable and the requirements made of the input signal capacity of the controller are correspondingly high in this case.

Published, Non-Prosecuted German Patent Application DE 28 00 810 A1 discloses a method for monitoring a moving machine part of a machine which is controlled by a control program, in which method the display values of monitoring sensors which are disposed around the machine part are sensed as a function of the position of the machine part and compared with corresponding, stored reference values. If the display values differ from the reference values, a fault message is output. A list with reference values given as a function of the position of the machine part must be produced when the machine is set up.

In a device for detecting the position of “mobile elements” which is known from Published, French Patent Application FR 2 558 278 A1, a plurality of position detectors are connected in series into a measuring line so that the activation of each position detector increases or reduces the overall resistance in the measuring line by a uniform value. The number of actuated position detectors that is determined from the overall resistance is checked, in the known device for fault detection, for compatibility with the instructions that are output to the automated apparatus.

### SUMMARY OF THE INVENTION

It is accordingly an object of the invention to provide a method and a device for monitoring a machine that overcome the above-mentioned disadvantages of the prior art devices and method of this general type, which method and device require particularly low technical expenditure.

With the foregoing and other objects in view there is provided, in accordance with the invention, a method for monitoring movements of machine parts of a machine controlled by a control program. The method includes continuously identifying and counting the machine parts requested to be actuated by the control program, simultaneously counting the machine parts actually moved by actuation, and displaying a fault message and identified machine parts as possible fault sources on a display device if a number of to be actuated machine parts and a number of actually moved machine parts at a given time differ from one another.

The advantage of the aforesaid method is in particular that it is possible to determine whether or not a fault is present solely from comparing the numbers of requested actuated machine parts and of moved machine parts at a given time. Furthermore, by including the knowledge of the identified machine parts which are requested to be actuated by the control program at a given time it is possible to narrow down the location of the fault to precisely those machine parts which are to be actuated by the control program at that particular time. If it is assumed that only a small number of machine parts of the machine are actuated and moved at the same time, a possible fault location is limited to precisely these few machine parts that are to be actuated or moved at the same time. Consequently, in order to detect a fault, the controller must merely obtain, as an input signal, the number of machine parts moved at a given time and compare them with the number of machine parts requested to be actuated by the controller at that particular time.

In an advantageous refinement of the invention, a movement of a moving machine part activates at least one electrical contact that is assigned to the respective machine part, and the number of moved machine parts is determined from the activations of the switching contacts.

In a further advantageous refinement of the invention, a two-terminal network is formed in each case from one of the switching contacts and a resistor, the two-terminal networks are connected together and the number of moved machine parts is determined from the overall resistance, at that time, of the two-terminal networks which are connected together.

Each activation of a switching contact changes the overall resistance of the two-terminal parts that are connected together. Therefore, the value, at a given time, of the overall resistance of the two-terminal networks that are connected together is a measure of how many machine parts are moved at that particular time.

The invention therefore leads to a device for monitoring movements of moving machine parts of a machine that is controlled by the control program.

In the device there are means for continuously identifying and counting the moving machine parts which are currently actuated by the control program, means for counting simultaneously the machine parts moved by the actuation, and means for displaying a fault message and the identified machine parts as possible fault sources on a display device if the numbers of actuated machine parts and of moved machine parts at a given time differ from one another.

In an advantageous refinement of the device according to the invention, the device is configured in such a way that at least one electrical switching contact which is assigned to the respective machine part can be actuated by a movement of a moving machine part, and the number of moved machine parts can be determined from the actuations of the switching contacts.

In a further advantageous refinement of the device according to the invention, the two-terminal network is formed from one of the switching contacts and a resistor in each case, the two-terminal networks are connected together and the number of machine parts at a given time is determined from the overall resistance, at that particular time, of the two-terminal networks which are connected together.

Other features which are considered as characteristic for the invention are set forth in the appended claims.

Although the invention is illustrated and described herein as embodied in a method and a device for monitoring a machine, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a block diagram of a machine that is connected to a controller and has moving machine parts that change the overall resistance of a measuring circuit by their movements;

FIG. 2 is a block diagram of a machine in which the moving machine parts are embodied as control armatures and the electrical switching contacts' as stop plates;

FIG. 3 is a circuit diagram of the interconnection of two-terminal networks which are formed from an electrical switching contact and a respectively assigned resistor in each case; and

FIG. 4 is a block diagram of a further interconnection of two-terminal networks.

### DESCRIPTION OF THE PREFERRED EMBODIMENTS

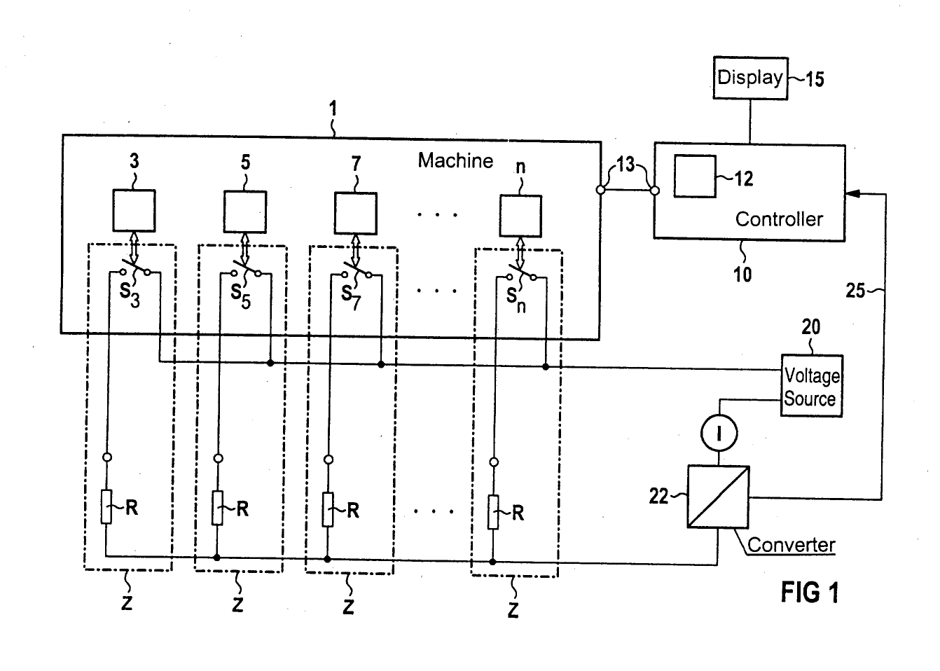

In all the figures of the drawing, sub-features and integral parts that correspond to one another bear the same reference symbol in each case. Referring now to the figures of the drawing in detail and first, particularly, to FIG. 1 thereof, there is shown a machine 1 having a plurality of moving machine parts 3, 5, 7, . . . n. Each moving machine part is assigned an electrical switching contact S3, S5, S7, . . . Sn. A movement of a moving machine part 3, 5, 7 . . . n activates the electrical switching contact S3, S5, S7 . . . Sn. A two-terminal network Z is formed from an electrical switching contact and a resistor R in each case. The two-terminal networks Z are connected together in parallel and are connected to a voltage source 20. In a measuring circuit that is formed in this way, there is also a current measuring device I and a converter 22. The machine 1 is connected via terminals 13 to a controller 10 that contains a control program 12 and is connected to a display device 15. While the machine 1 is operating, the controller 10 continuously identifies the moving machine parts that are requested to be actuated by the control program at a given time.

The number of moved machine parts is determined by measuring the current in the measuring circuit, composed of the two-terminal networks Z connected in parallel, and the voltage source 20, by the current measuring device I, and converting the current in the converter 22 into a current measuring value 25 which can be processed by the controller 10 and which the controller 10 reads in.

The value of the measured value 25 of the current at a given time is a measure of how many machine parts are being moved at that particular time. The measured value 25 of the current at a given time can only assume one of a finite number of discrete values which are respectively determined by the resistance values of the two-terminal networks Z at given times, which resistance values are connected into the measuring circuit.

The controller 10 compares the number of moving machine parts which are to be actuated at a given time and the number of actually moved machine parts which is determined by the measured value 25 of the current at the given time. If these numbers for a given time differ from one another, a fault message and the currently identified to be actuated machine parts as possible fault sources are output on the display device 15.

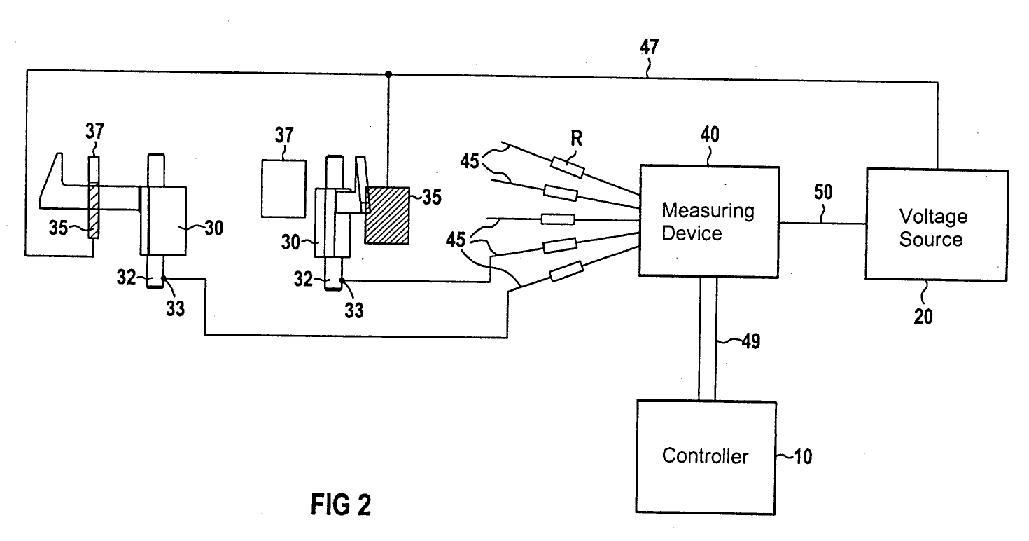

FIG. 2 shows an electric machine that is embodied as a circular knitting machine. The selection apparatus for selecting the needles is controlled by a control armature 30 which constitute moving machine parts. Each control armature 30 has two stop plates 35 and 37. Contact is made with a bearing shaft 32 of each control armature 30 by a sliding contact 33, for example. Each sliding contact 33 is connected via a resistor R to a measuring device 40 using a connecting line 45. The stop plates 35 whose stop needs to be detected by the control armature 30 are connected to one another via a connecting line 47 and to the voltage source 20. The controller 10 contains the control program for the circular knitting machine and is connected to the measuring device 40 via a connecting line 49. The actuation of the control armature 30 by the controller 10 and the actuation device of the control armature are not illustrated in FIG. 2.

If the control armature 30 impacts against the stop plate 35 with which electrical contact has been made, a current flows through the connecting line 45 from the voltage source 20 via the measuring device 40 and via the resistor R assigned to the respective control armature 30, the current being transmitted to the respective control armature 30 by the respective sliding contact 33 and flowing from the control armature 30 back to the voltage source 20 via the respective contact plate 35 which has been impacted against, and via the connecting line 47. The value of the current 50 in the previously described measuring circuit is determined by how many control armatures 30 impact simultaneously against a stop plate 35 with which contact has been made, thus changing the overall resistance in the measuring circuit by adding or removing a parallel resistor R.

If the circular knitting machine contains, for example, n control armatures which are each assigned a stop plate 35 with which electrical contact is made, the current 50 in the measuring circuit can thus assume n+1 different discrete values in each operating situation of the circular knitting machine. The number of control armatures 30 which impact at a given time against the stop plate 35 with which contact has been made can thus be unambiguously determined from a value of the current 50 in the measuring circuit at a given time. In the measuring device 40, the value of the current 50 in the measuring circuit is converted into a value that can be processed by the controller 10, and is transmitted to the controller 10 via the connecting line 49.

The controller 10 identifies the control armatures 30 which are to be actuated at a given time by the program running in it, and determines their number. The number of control armatures that are to be actuated at a given time is compared by the controller 10 with the number of control armatures which are actually moved at that particular time and which is determined by the value of the current 50 in the measuring circuit at a given time. If both numbers differ from one another, the controller 10 outputs a fault message and the identified currently actuated control armatures as possible fault sources on a display device.

The number of possible fault sources which are output can be reduced, for example, by setting up a plurality of the above-mentioned measuring circuits and assigning each measuring circuit to a group—for example a series—of control armatures in each case. The possible fault sources are thus narrowed down to the control armatures within this group of control armatures that are actuated by the controller 10 at a given time. By forming groups skillfully with knowledge of the normal operating sequence of the machine it is even possible to limit the possible fault sources precisely to the defective control armature and output them.

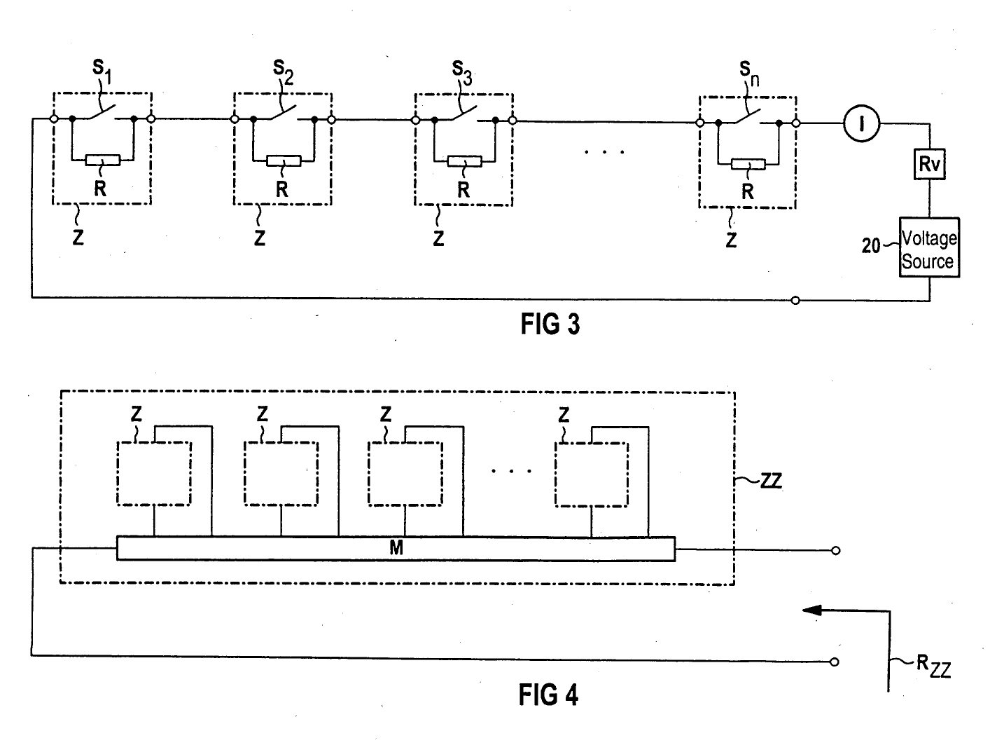

FIG. 3 illustrates the interconnection of the two-terminal networks Z to form a measuring circuit. Each two-terminal network Z is formed here from the parallel connection of an electrical switching contact S1, S2, S3, . . . Sn and an electrical resistor R. The individual two-terminal networks Z are connected together to form a series circuit. Each activation of an electrical switching contact S1, S2, S3, . . . Sn via a respectively assigned machine part changes the overall resistance of the series connection of the individual two-terminal networks Z. The current which is output by the voltage source 20 via its series resistor Rv to the interconnection of the two-terminal networks Z is thus independent of how many of the electrical switching contacts S1, S2, S3, . . . Sn are activated. The current is registered by the current measuring device I and is thus a measure of the number of machine parts moved at a given time.

The electrical switching contacts S1, S2, S3, . . . . Sn can be embodied either as opening or as closing contacts.

FIG. 4 shows the interconnection of two-terminal networks Z in a switching matrix M to form a two-terminal network ZZ.

The way in which the individual two-terminal networks Z are connected to form an overall two-terminal network ZZ is defined in the switching matrix M. Any desired combinations of series connections and parallel connections of two-terminal network Z may be defined here. Each two-terminal networks Z is composed of the interconnection of an electrical switching contact that is assigned to a moving machine part, and a resister R.

A value of the overall resistance R_{ZZ} of the two-terminal network ZZ at a given time is a measure of how many moving machine parts are moved at a given time.

Apart from the interconnection of the individual two-terminal networks Z to form a two-terminal network ZZ, it is also conceivable to interconnect the two-terminal networks Z in a different way. It is possible, for example, also to form two-port networks or four-port or even generally multi-port networks from the individual two-terminal networks Z. A value of the resistance between two terminals of such a multi-port network at a given time is then a measure of how many moving machine parts are moved at that particular time. The interconnection of two-terminal networks Z to form a multi-port network is not illustrated in more detail in FIG. 4.

We claim:

1. A method for monitoring movements of machine parts of a machine controlled by a control program, which comprises the steps of:
continuously identifying and counting the machine parts requested to be actuated by the control program;
simultaneously counting the machine parts actually moved by actuation; and
displaying a fault message and identified machine parts as possible fault sources on a display device if a number of to be actuated machine parts and a number of actually moved machine parts at a given time differ from one another.

2. The method according to claim 1, which further comprises:
activating at least one electrical switching contact associated with a respective machine part in response to movement of the respective machine part; and
determining the number of actually moved machine parts from activations of switching contacts.

3. The method according to claim 2, which further comprises:
forming a plurality of two-terminal networks, each of the two-terminal networks formed from one of the switching contacts and a resistor, the two-terminal networks are connected to each other; and
determining the number of actually moved machine parts at the given time from an overall resistance at the given time of the two-terminal networks.

4. A device for monitoring movements of machine parts of a machine controlled by a control program, the device comprising:
means for continuously identifying and counting the machine parts requested to be actuated by the control program;
means for simultaneously counting the machine parts actually moved by actuation;
a display device; and
means for displaying a fault message and identified machine parts as possible fault sources on said display device if a number of to be actuated machine parts and a number actually moved machine parts at a given time differ from one another.

5. The device according to claim 4, further comprising electrical switching contacts, at least one of said electrical switching contacts is associated with a respective machine part and is actuated by a movement of the respective machine part, the number of actually moved machine parts is determined from activations of said electrical switching contacts.

6. The device according to claim 5, further comprising a plurality of resistors connected to said electrical switching contacts, a combination of one of said electrical switching contacts and one of said resistors defining a two-terminal network in each case and resulting in a plurality of two-terminal networks connected to each other, and the number of actually moved machine parts at the given time is determined from an overall resistance of said two-terminal networks connected together.

7. A device for monitoring movements of machine parts of a machine controlled by a control program, the device comprising:
a controller for continuously identifying and counting the machine parts requested to be actuated by the control program;
a measuring circuit for assisting in simultaneously counting the machine parts actually moved by actuation and connected to said controller; and
a display device connected to said controller, said display device displaying a fault message and identified machine parts as possible fault sources if a number of to be actuated machine parts and a number actually moved machine parts at a given time differ from one another.

8. The device according to claim 7, wherein said measuring circuit includes electrical switching contacts, at least one of said electrical switching contacts is associated with a respective machine part and is actuated by a movement of the respective machine part, the number of actually moved machine parts is determined from activations of said electrical switching contacts.

9. The device according to claim 8, wherein said measuring circuit includes a plurality of resistors connected to said electrical switching contacts, a combination of one of said electrical switching contacts and one of said resistors defines a two-terminal network in each case and results in a plurality of two-terminal networks connected to each other, and the number of actually moved machine parts at the given time is determined from an overall resistance of said two-terminal networks connected together.
